(19) United States
(12) Patent Application Publication
(10) Pub. No.: US 2023/0127687 A1
(43) Pub. Date: Apr. 27, 2023

(54) HIGH FREQUENCY TRANSMISSION CABLE

(71) Applicant: Cheng Uei Precision Industry Co., Ltd., New Taipei City (TW)

(72) Inventors: Lin Yean Lin, New Taipei City (TW); Shih Hsun Tu, New Taipei City (TW)

(21) Appl. No.: 17/865,452

(22) Filed: Jul. 15, 2022

(30) Foreign Application Priority Data
Oct. 24, 2021 (CN) 202122636166.0

(51) Int. Cl. H01B 11/18; H01B 7/02; H01B 3/42

(52) U.S. Cl. CPC H01B 11/18; H01B 7/0216; H01B 3/422

(57) ABSTRACT

A high frequency transmission cable is matched with a circuit board. The circuit board is equipped with a conducting portion and a grounding portion. The high frequency transmission cable includes a conducting wire, a first insulating layer surrounding the conducting wire, an aluminum foil layer and a second insulating layer. The aluminum foil layer surrounds the first insulating layer. An outer surface of the aluminum foil layer is a conducting surface. The second insulating layer surrounds the aluminum foil layer. The second insulating layer surrounds the conducting surface of the aluminum foil layer. The conducting wire is connected with the conducting portion. The conducting surface of the aluminum foil layer is connected with the grounding portion, so that the high frequency transmission cable has a grounding effect.

### CROSS-REFERENCE TO RELATED APPLICATION

The present application is based on, and claims priority from, China Patent Application No. 202122636166.0, filed Oct. 24, 2021, the disclosure of which is hereby incorporated by reference herein in its entirety.

### BACKGROUND OF THE INVENTION

### 1. Field of the Invention

The present invention generally relates to a high frequency transmission cable, and more particularly to a high frequency transmission cable without a grounding wire, and the high frequency transmission cable has a grounding function.

### 2. The Related Art

With reference to FIG. 5 to FIG. 8, a current high frequency transmission cable 300 is matched with a circuit board 400 in a prior art. The high frequency transmission cable 300 includes a conducting wire 10. The conducting wire 10 is sequentially surrounded by a first insulating layer 20, an aluminum foil layer 30 and a second insulating layer 40. The aluminum foil layer 30 further surrounds a grounding wire 70, and the grounding wire 70 is in contact with the aluminum foil layer 30. The circuit board 400 is equipped with a conducting portion 50 and a grounding portion 60. The conducting wire 10 is soldered with the conducting portion 50. The grounding wire 70 is soldered with the grounding portion 60.

However, in a process of assembling the current high frequency transmission cable 300 with the circuit board 400, the grounding wire 70 of the current high frequency transmission cable 300 must be bent to a position of the grounding portion 60 of the circuit board 400 in advance. Due to a small size of the grounding wire 70, a bending operation of the grounding wire 70 is more complicated, and the bending operation of the grounding wire 70 is difficultly operated.

Thus, it is necessary to provide a high frequency transmission cable without a grounding wire, a manufacturing process of the high frequency transmission cable is simplified. The high frequency transmission cable is able to save a volume which is required by the grounding wire, the high frequency transmission cable has a grounding function, and the high frequency transmission cable maintains the grounding function to save a volume of the high frequency transmission cable.

### SUMMARY OF THE INVENTION

An object of the present invention is to provide a high frequency transmission cable matched with a circuit board. The circuit board is equipped with a conducting portion and a grounding portion. The conducting portion extends along a longitudinal direction. The grounding portion extends along a transverse direction. The grounding portion is located behind the conducting portion. The high frequency transmission cable includes a conducting wire, a first insulating layer surrounding the conducting wire, an aluminum foil layer and a second insulating layer. A front end of the conducting wire projects beyond a front surface of the first insulating layer. The aluminum foil layer surrounds the first insulating layer together with the conducting wire. An inner surface of the aluminum foil layer is an insulating surface, and an outer surface of the aluminum foil layer is a conducting surface. The insulating surface of the aluminum foil layer surrounds the first insulating layer. A front end of the first insulating layer projects beyond a front surface of the aluminum foil layer. The second insulating layer surrounds the aluminum foil layer together with the first insulating layer and the conducting wire. The second insulating layer surrounds the conducting surface of the aluminum foil layer. A front end of the aluminum foil layer projects beyond a front surface of the second insulating layer. A front end of the conducting surface projects beyond the front surface of the second insulating layer. The conducting wire is surrounded by the first insulating layer, the aluminum foil layer and the second insulating layer in sequence. the front end of the conducting wire contacts with the conducting portion. The front end of the conducting wire is connected with the conducting portion. The front end of the conducting surface of the aluminum foil layer contacts with the grounding portion. The conducting surface of the aluminum foil layer is connected with the grounding portion, so that the high frequency transmission cable has a grounding effect.

Another object of the present invention is to provide a high frequency transmission cable mounted to a circuit board. The circuit board is equipped with two conducting portions and one grounding portion. The two conducting portions are spaced from each other. The two conducting portions extend along a longitudinal direction. The one grounding portion extends along a transverse direction. The two conducting portions are arranged transversely. The one grounding portion is located behind the two conducting portions. The high frequency transmission cable includes two conducting wires abreast arranged transversely, two first insulating layers, an aluminum foil layer and a second insulating layer. The two first insulating layers surround the two conducting wires, respectively. Two front ends of the two conducting wires project beyond two front surfaces of the two first insulating layers. The aluminum foil layer surrounds the two first insulating layers together with the two conducting wires. An inner surface of the aluminum foil layer is an insulating surface, and an outer surface of the aluminum foil layer is a conducting surface. The insulating surface of the aluminum foil layer surrounds the two first insulating layers. Two front ends of the two first insulating layers project beyond a front surface of the aluminum foil layer. The second insulating layer surrounds the aluminum foil layer together with the two first insulating layers and the two conducting wires. The second insulating layer surrounds the conducting surface of the aluminum foil layer. A front end of the aluminum foil layer projects beyond a front surface of the second insulating layer. A front end of the conducting surface projects beyond the front surface of the second insulating layer. The two conducting wires are surrounded by the two first insulating layers, the aluminum foil layer and the second insulating layer in sequence. The two front ends of the two conducting wires contact with the two conducting portions. The two front ends of the two conducting wires are connected with the two conducting portions. The front end of the conducting surface of the aluminum foil layer contacts with the one grounding portion. The conducting surface of the aluminum foil layer is connected with the one grounding portion, so that the high frequency transmission cable has a grounding effect.

Another object of the present invention is to provide a high frequency transmission cable. The high frequency transmission cable is without a grounding wire. The high frequency transmission cable has a grounding function. The high frequency transmission cable is soldered to a circuit board. The circuit board is equipped with two conducting portions and one grounding portion. The two conducting portions are spaced from each other. The two conducting portions extend along a longitudinal direction. The one grounding portion extends along a transverse direction. The two conducting portions are arranged transversely. The one grounding portion is located behind the two conducting portions. The high frequency transmission cable includes two conducting wires abreast arranged transversely, two first insulating layers, an aluminum foil layer and a second insulating layer. The two first insulating layers surround the two conducting wires, respectively. Two front ends of the two conducting wires project beyond two front surfaces of the two first insulating layers. The aluminum foil layer surrounds the two first insulating layers together with the two conducting wires. An inner surface of the aluminum foil layer is an insulating surface, and an outer surface of the aluminum foil layer is a conducting surface. The conducting surface of the aluminum foil layer is disposed at an outermost surface of the aluminum foil layer. The insulating surface of the aluminum foil layer surrounds the two first insulating layers. Two front ends of the two first insulating layers project beyond a front surface of the aluminum foil layer. The second insulating layer surrounds the aluminum foil layer together with the two first insulating layers and the two conducting wires. The second insulating layer surrounds the conducting surface of the aluminum foil layer. A front end of the aluminum foil layer projects beyond a front surface of the second insulating layer. A front end of the conducting surface projects beyond the front surface of the second insulating layer. The two conducting wires are surrounded by the two first insulating layers, the aluminum foil layer and the second insulating layer in sequence. The two front ends of the two conducting wires contact with the two conducting portions. The two front ends of the two conducting wires are soldered to the two conducting portions. The front end of the conducting surface of the aluminum foil layer contacts with the one grounding portion. The front end of the conducting surface of the aluminum foil layer is soldered to the one grounding portion, so that the high frequency transmission cable has a grounding effect.

As described above, the conducting surface of the aluminum foil layer is disposed at the outermost surface of the aluminum foil layer of the high frequency transmission cable, and the conducting surface of the aluminum foil layer is soldered to the grounding portion of the circuit board, so that the high frequency transmission cable has the grounding effect by the circuit board, and a manufacturing process of the high frequency transmission cable is simplified. Furthermore, the high frequency transmission cable is without the grounding wire, the high frequency transmission cable is able to save a volume which is required by the grounding wire, the high frequency transmission cable has the grounding function, the high frequency transmission cable maintains the grounding function to save a volume of the high frequency transmission cable, so the volume of the high frequency transmission cable is reduced, an insertion loss of the high frequency transmission cable is promoted, and a delay difference within a signal pair is better to achieve an anti-electromagnetic interference effect of the high frequency transmission cable.

### BRIEF DESCRIPTION OF THE DRAWINGS

The present invention will be apparent to those skilled in the art by reading the following description, with reference to the attached drawings, in which:

FIG. 1 is a perspective view of a high frequency transmission cable according to the present invention, wherein the high frequency transmission cable is matched with a circuit board;

FIG. 2 is an enlarged view of an encircled portion II of the high frequency transmission cable of FIG. 1;

FIG. 3 is a perspective view of the high frequency transmission cable according to the present invention, wherein the high frequency transmission cable is moved away from the circuit board;

FIG. 4 is a cross-section view of the high frequency transmission cable along a line IV-IV of FIG. 3;

FIG. 5 is a perspective view of a high frequency transmission cable, wherein the high frequency transmission cable is matched with a circuit board in a prior art;

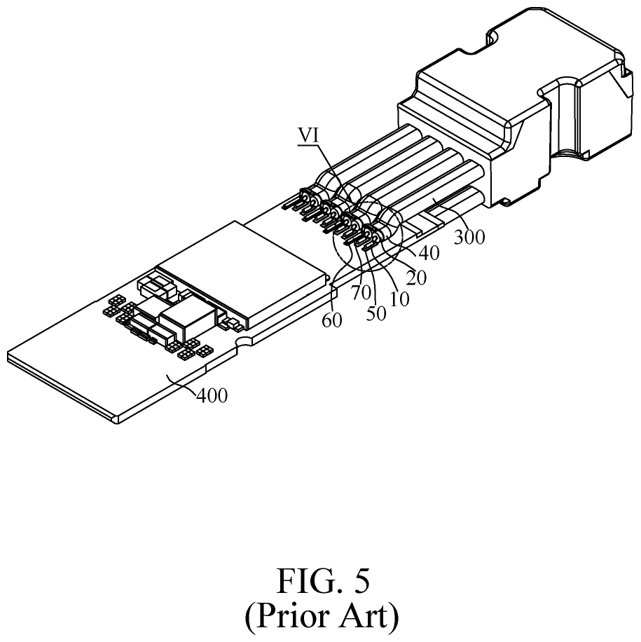

FIG. 6 is an enlarged view of an encircled portion VI of the high frequency transmission cable of FIG. 5;

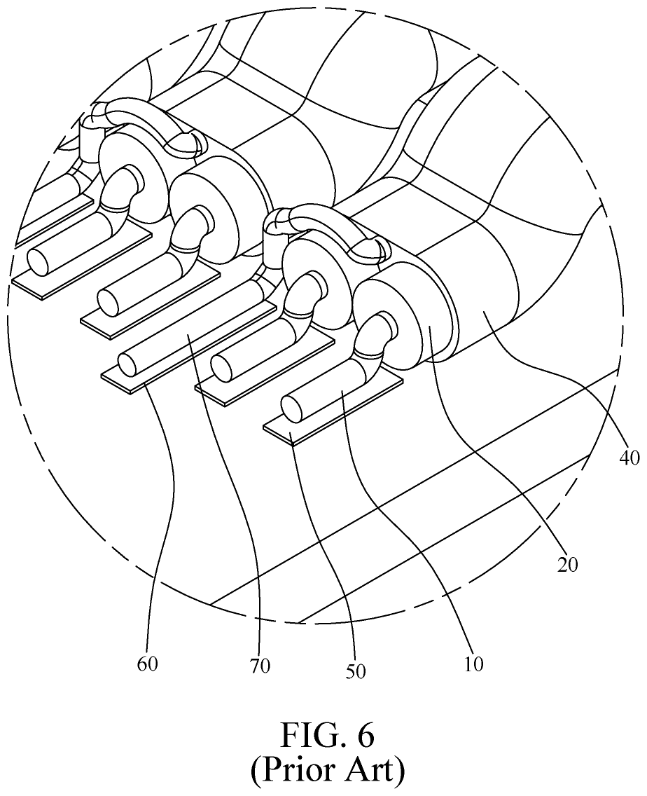

FIG. 7 is a perspective view of the high frequency transmission cable, wherein the high frequency transmission cable is moved away from the circuit board in the prior art; and

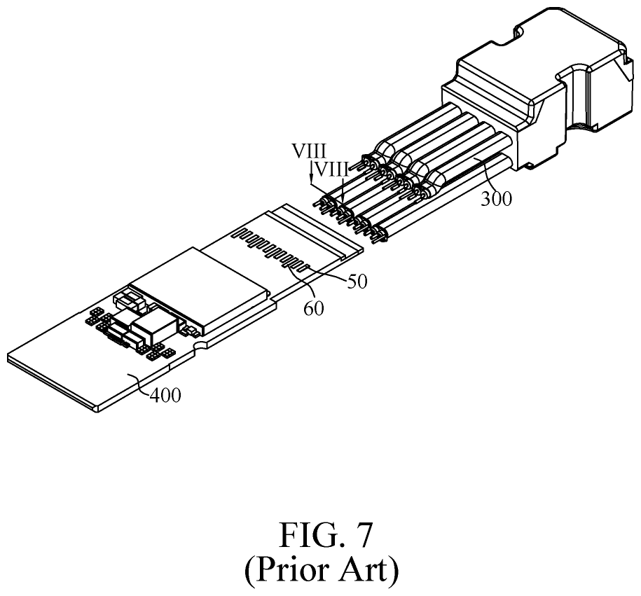

FIG. 8 is a cross-section view of the high frequency transmission cable along a line VIII-VIII of FIG. 7.

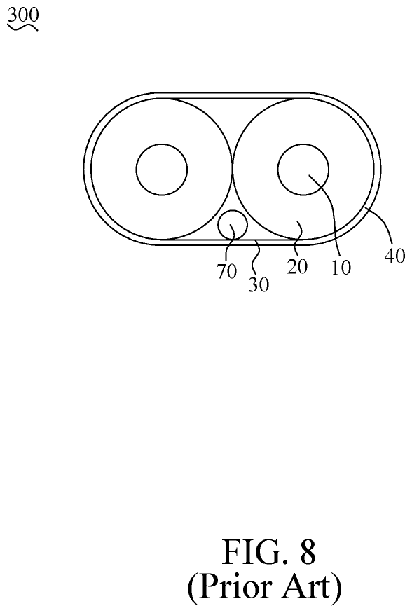

### DETAILED DESCRIPTION OF THE PREFERRED EMBODIMENT

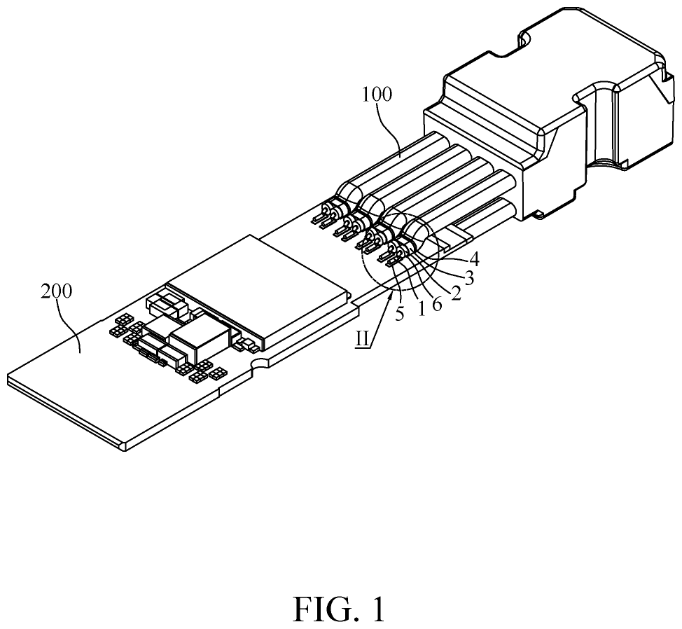

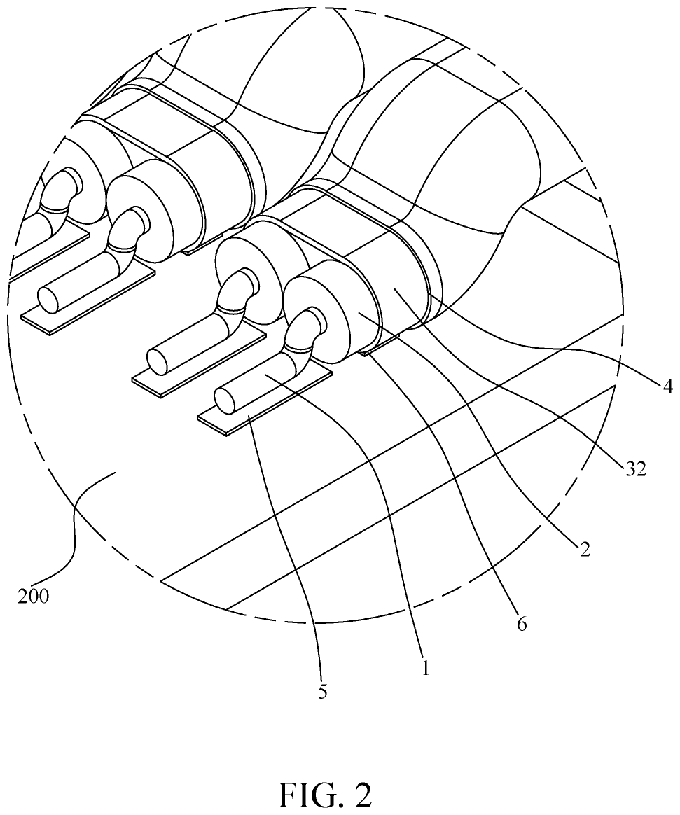

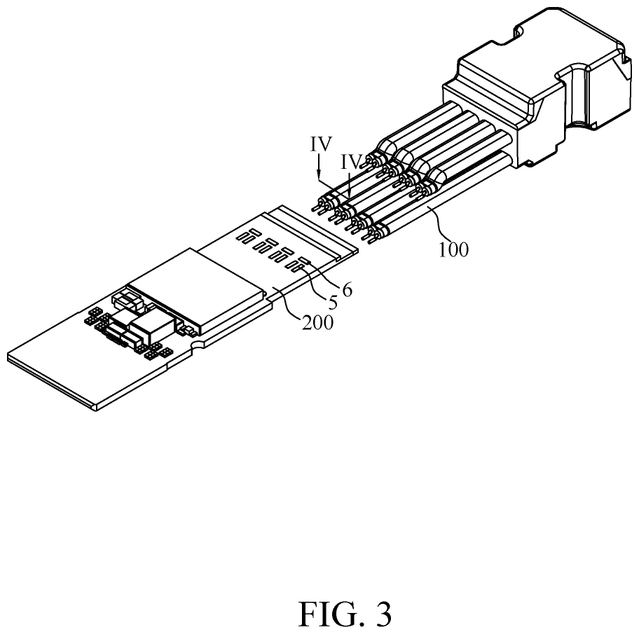

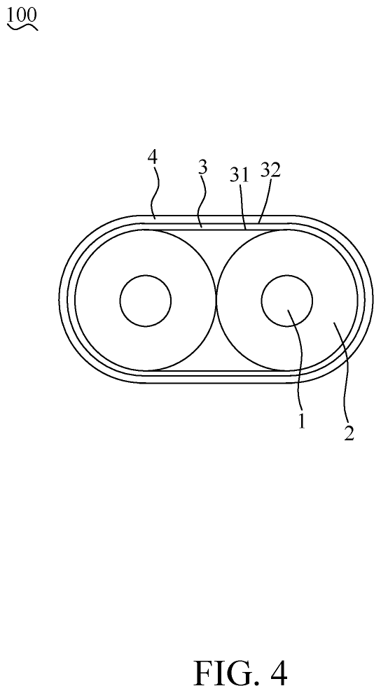

With reference to FIG. 1 to FIG. 4, a high frequency transmission cable 100 in accordance with the present invention is shown. The high frequency transmission cable 100 is matched with a circuit board 200. The high frequency transmission cable 100 is cooperated with the circuit board 200. The high frequency transmission cable 100 includes a conducting wire 1, a first insulating layer 2 surrounding the conducting wire 1, an aluminum foil layer 3 surrounding the first insulating layer 2 together with the conducting wire 1, and a second insulating layer 4 surrounding the aluminum foil layer 3 together with the first insulating layer 2 and the conducting wire 1.

The conducting wire 1 is surrounded by the first insulating layer 2, the aluminum foil layer 3 and the second insulating layer 4 in sequence. The first insulating layer 2 surrounds a rear end of the conducting wire 1. The aluminum foil layer 3 surrounds a rear end of the first insulating layer 2 together with the rear end of the conducting wire 1. The second insulating layer 4 surrounds a rear end of the aluminum foil layer 3 together with the rear end of the first insulating layer 2 and the rear end of the conducting wire 1. A front end of the aluminum foil layer 3 projects beyond a front surface of the second insulating layer 4. A front end of the first insulating layer 2 projects beyond a front surface of the aluminum foil layer 3. A front end of the conducting wire 1 projects beyond a front surface of the first insulating layer 2.

Specifically, the high frequency transmission cable 100 includes two conducting wires 1, two first insulating layers 2, the aluminum foil layer 3 and the second insulating layer 4. The two conducting wires 1 are abreast arranged transversely. The two first insulating layers 2 surround the two conducting wires 1, respectively. The aluminum foil layer 3 surrounds the two first insulating layers 2 together with the two conducting wires 1. The second insulating layer 4 surrounds the aluminum foil layer 3 together with the two first insulating layers 2 and the two conducting wires 1.

The two conducting wires 1 are surrounded by the two first insulating layers 2, the aluminum foil layer 3 and the second insulating layer 4 in sequence. The two first insulating layers 2 surround the two rear ends of the two conducting wires 1. The aluminum foil layer 3 surrounds the two rear ends of the two first insulating layers 2 together with the two rear ends of the two conducting wires 1. The second insulating layer 4 surrounds the rear end of the aluminum foil layer 3 together with the two rear ends of the two first insulating layers 2 and the two rear ends of the two conducting wires 1. The two front ends of the two first insulating layers 2 project beyond the front surface of the aluminum foil layer 3. The two front ends of the two conducting wires 1 project beyond the two front surfaces of the two first insulating layers 2.

Preferably, a plurality of the high frequency transmission cables 100 are mounted to the circuit board 200. The plurality of the high frequency transmission cables 100 are soldered to the circuit board 200.

An inner surface of the aluminum foil layer 3 is an insulating surface 31, and an outer surface of the aluminum foil layer 3 is a conducting surface 32. The insulating surface 31 of the aluminum foil layer 3 surrounds the first insulating layer 2. The second insulating layer 4 surrounds the conducting surface 32 of the aluminum foil layer 3. A front end of the conducting surface 32 projects beyond the front surface of the second insulating layer 4. A front end of the insulating surface 31 projects beyond the front surface of the second insulating layer 4. The insulating surface 31 of the aluminum foil layer 3 surrounds the two first insulating layers 2.

The second insulating layer 4 is made of polyethylene terephthalate (PET).

The circuit board 200 is equipped with a conducting portion 5 and a grounding portion 6. The conducting portion 5 extends along a longitudinal direction. The grounding portion 6 extends along a transverse direction. The grounding portion 6 and the conducting portion 5 are arranged along the longitudinal direction. The grounding portion 6 is located behind the conducting portion 5. The front end of the conducting wire 1 contacts with the conducting portion 5. The front end of the conducting wire 1 is connected with the conducting portion 5. The front end of the conducting surface 32 of the aluminum foil layer 3 contacts with the grounding portion 6. The front end of the conducting surface 32 of the aluminum foil layer 3 is connected with the grounding portion 6, in this way, the high frequency transmission cable 100 has a grounding effect by the circuit board 200, a volume of the high frequency transmission cable 100 is reduced, an insertion loss of the high frequency transmission cable 100 is promoted, and a delay difference within a signal pair is better to achieve an anti-electromagnetic interference effect of the high frequency transmission cable 100.

Specifically, the circuit board 200 is equipped with a plurality of the conducting portions 5 and a plurality of the grounding portions 6. The plurality of the conducting portions 5 and the grounding portions 6 are divided into a plurality of groups. The circuit board 200 is equipped with two conducting portions 5 and one grounding portion 6 in each group. The two conducting portions 5 are spaced from each other. The two conducting portions 5 extend along the longitudinal direction. The one grounding portion 6 extends along the transverse direction. The two conducting portions 5 are arranged transversely. The one grounding portion 6 and the two conducting portions 5 are arranged along the longitudinal direction. The one grounding portion 6 is located behind the two conducting portions 5. The two front ends of the two conducting wires 1 contact with the two conducting portions 5. The two front ends of the two conducting wires 1 are connected with the two conducting portions 5. The front end of the conducting surface 32 of the aluminum foil layer 3 contacts with the one grounding portion 6, the conducting surface 32 of the aluminum foil layer 3 is connected with the one grounding portion 6, so that the high frequency transmission cable 100 has the grounding effect.

With reference to FIG. 1 to FIG. 4, in a manufacturing process of the high frequency transmission cable 100, because a grounding wire is unnecessary to be disposed to the high frequency transmission cable 100, and the conducting surface 32 of the aluminum foil layer 3 is disposed at an outermost surface of the aluminum foil layer 3. Therefore, only the second insulating layer 4 which is located at a free end of the high frequency transmission cable 100 needs to be removed, and the conducting surface 32 of the aluminum foil layer 3 is exposed. The high frequency transmission cable 100 is mounted to the circuit board 200. The high frequency transmission cable 100 is soldered to the circuit board 200. When the high frequency transmission cable 100 is mounted to the circuit board 200, at first, the front end of the conducting wire 1 is soldered to the conducting portion 5 of the circuit board 200, and then the front end of the conducting surface 32 of the aluminum foil layer 3 is soldered to the grounding portion 6 of the circuit board 200, so that the high frequency transmission cable 100 is soldered to the circuit board 200, in this way, a setting of the high frequency transmission cable 100 is completed. The high frequency transmission cable 100 has a simpler manufacturing process.

Specifically, when the high frequency transmission cable 100 is soldered to the circuit board 200, at first, the two front ends of the two conducting wires 1 contact with the two conducting portions 5 of the two circuit boards 200, and the two front ends of the two conducting wires 1 are soldered to the two conducting portions 5 of the two circuit boards 200, and then the front end of the conducting surface 32 of the aluminum foil layer 3 contacts with the one grounding portion 6, and the front end of the conducting surface 32 of the aluminum foil layer 3 is soldered to the grounding portion 6 of the circuit board 200, so that the high frequency transmission cable 100 is soldered to the circuit board 200.

When the plurality of the high frequency transmission cables 100 are mounted to the circuit board 200, each high frequency transmission cables 100 is mounted to the circuit board 200, at first, the two front ends of the two conducting wires 1 contact with the two conducting portions 5 of the two circuit boards 200, and the two front ends of the two conducting wires 1 are soldered to the two conducting portions 5 of the two circuit boards 200, and then the front end of the conducting surface 32 of the aluminum foil layer 3 contacts with the one grounding portion 6, and the front end of the conducting surface 32 of the aluminum foil layer 3 is soldered to the grounding portion 6 of the circuit board 200, so that the plurality of the high frequency transmission cables 100 are soldered to the circuit board 200.

As described above, the conducting surface 32 of the aluminum foil layer 3 is disposed at the outermost surface of the aluminum foil layer 3 of the high frequency transmission cable 100, and the conducting surface 32 of the aluminum foil layer 3 is soldered to the grounding portion 6 of the circuit board 200, so that the high frequency transmission cable 100 has the grounding effect by the circuit board 200, and the manufacturing process of the high frequency transmission cable 100 is simplified. Furthermore, the high frequency transmission cable 100 is without the grounding wire, the high frequency transmission cable 100 is able to save a volume which is required by the grounding wire, the high frequency transmission cable 100 has a grounding function, the high frequency transmission cable 100 maintains the grounding function to save the volume of the high frequency transmission cable 100, so the volume of the high frequency transmission cable 100 is reduced, the insertion loss of the high frequency transmission cable 100 is promoted, and the delay difference within the signal pair is better to achieve the anti-electromagnetic interference effect of the high frequency transmission cable 100.

What is claimed is:

1. A high frequency transmission cable matched with a circuit board, the circuit board being equipped with a conducting portion and a grounding portion, the conducting portion extending along a longitudinal direction, the grounding portion extending along a transverse direction, the grounding portion being located behind the conducting portion, the high frequency transmission cable comprising:
a conducting wire;
a first insulating layer surrounding the conducting wire, a front end of the conducting wire projecting beyond a front surface of the first insulating layer;
an aluminum foil layer surrounding the first insulating layer together with the conducting wire, an inner surface of the aluminum foil layer being an insulating surface, and an outer surface of the aluminum foil layer being a conducting surface, the insulating surface of the aluminum foil layer surrounding the first insulating layer, a front end of the first insulating layer projecting beyond a front surface of the aluminum foil layer; and
a second insulating layer surrounding the aluminum foil layer together with the first insulating layer and the conducting wire, the second insulating layer surrounding the conducting surface of the aluminum foil layer, a front end of the aluminum foil layer projecting beyond a front surface of the second insulating layer, a front end of the conducting surface projecting beyond the front surface of the second insulating layer,
wherein the conducting wire is surrounded by the first insulating layer, the aluminum foil layer and the second insulating layer in sequence, the front end of the conducting wire contacts with the conducting portion, the front end of the conducting wire is connected with the conducting portion, the front end of the conducting surface of the aluminum foil layer contacts with the grounding portion, the conducting surface of the aluminum foil layer is connected with the grounding portion, so that the high frequency transmission cable has a grounding effect.

2. The high frequency transmission cable as claimed in claim 1, wherein the second insulating layer is made of polyethylene terephthalate (PET).

3. The high frequency transmission cable as claimed in claim 1, wherein the conducting surface of the aluminum foil layer is disposed at an outermost surface of the aluminum foil layer.

4. A high frequency transmission cable mounted to a circuit board, the circuit board being equipped with two conducting portions and one grounding portion, the two conducting portions being spaced from each other, the two conducting portions extending along a longitudinal direction, the one grounding portion extending along a transverse direction, the two conducting portions being arranged transversely, the one grounding portion being located behind the two conducting portions, the high frequency transmission cable comprising:
two conducting wires abreast arranged transversely;
two first insulating layers surrounding the two conducting wires, respectively, two front ends of the two conducting wires projecting beyond two front surfaces of the two first insulating layers;
an aluminum foil layer surrounding the two first insulating layers together with the two conducting wires, an inner surface of the aluminum foil layer being an insulating surface, and an outer surface of the aluminum foil layer being a conducting surface, the insulating surface of the aluminum foil layer surrounding the two first insulating layers, two front ends of the two first insulating layers projecting beyond a front surface of the aluminum foil layer; and
a second insulating layer surrounding the aluminum foil layer together with the two first insulating layers and the two conducting wires, the second insulating layer surrounding the conducting surface of the aluminum foil layer, a front end of the aluminum foil layer projecting beyond a front surface of the second insulating layer, a front end of the conducting surface projecting beyond the front surface of the second insulating layer,
wherein the two conducting wires are surrounded by the two first insulating layers, the aluminum foil layer and the second insulating layer in sequence, the two front ends of the two conducting wires contact with the two conducting portions, the two front ends of the two conducting wires are connected with the two conducting portions, the front end of the conducting surface of the aluminum foil layer contacts with the one grounding portion, the conducting surface of the aluminum foil layer is connected with the one grounding portion, so that the high frequency transmission cable has a grounding effect.

5. The high frequency transmission cable as claimed in claim 4, wherein the second insulating layer is made of polyethylene terephthalate (PET).

6. The high frequency transmission cable as claimed in claim 4, wherein the conducting surface of the aluminum foil layer is disposed at an outermost surface of the aluminum foil layer.

7. A high frequency transmission cable without a grounding wire, the high frequency transmission cable having a grounding function, the high frequency transmission cable being soldered to a circuit board, the circuit board being equipped with two conducting portions and one grounding portion, the two conducting portions being spaced from each other, the two conducting portions extending along a longitudinal direction, the one grounding portion extending along a transverse direction, the two conducting portions being arranged transversely, the one grounding portion being located behind the two conducting portions, the high frequency transmission cable comprising:
two conducting wires abreast arranged transversely;
two first insulating layers surrounding the two conducting wires, respectively, two front ends of the two conducting wires projecting beyond two front surfaces of the two first insulating layers;
an aluminum foil layer surrounding the two first insulating layers together with the two conducting wires, an inner surface of the aluminum foil layer being an insulating surface, and an outer surface of the aluminum foil layer being a conducting surface, the conducting surface of the aluminum foil layer being disposed at an outermost surface of the aluminum foil layer, the insulating surface of the aluminum foil layer surrounding the two first insulating layers, two front ends of the two first insulating layers projecting beyond a front surface of the aluminum foil layer; and
a second insulating layer surrounding the aluminum foil layer together with the two first insulating layers and the two conducting wires, the second insulating layer surrounding the conducting surface of the aluminum foil layer, a front end of the aluminum foil layer projecting beyond a front surface of the second insulating layer, a front end of the conducting surface projecting beyond the front surface of the second insulating layer,
wherein the two conducting wires are surrounded by the two first insulating layers, the aluminum foil layer and the second insulating layer in sequence, the two front ends of the two conducting wires contact with the two conducting portions, the two front ends of the two conducting wires are soldered to the two conducting portions, the front end of the conducting surface of the aluminum foil layer contacts with the one grounding portion, the front end of the conducting surface of the aluminum foil layer is soldered to the one grounding portion, so that the high frequency transmission cable has a grounding effect.
